(19) United States
(12) Patent Application Publication
(10) Pub. No.: US 2007/0073827 A1
(43) Pub. Date: Mar. 29, 2007

(54) Method and system for communicating by way of a physical location

(75) Inventors: Naoufel Chraiet, Grenoble (FR); Gilles Privat, Meylan (FR); Jean-Paul Viboud, Le Touvet (FR)

Correspondence Address: MCKENNA LONG & ALDRIDGE LLP, 1900 K STREET, NW, WASHINGTON, DC, 20006, US

(73) Assignee: FRANCE TELECOM, Paris (FR)

(21) Appl. No.: 10/580,862

(22) PCT Filed: Dec. 3, 2004
(86) PCT No.: PCT/FR04/03118

§ 371 Date: May 26, 2006

(30) Foreign Application Priority Data
Dec. 5, 2003 (FR) 0314318

(51) Int. Cl. G06F 15/16

(52) U.S. Cl. 709/217

(57) ABSTRACT

A method for managing information between communicating objects, the information originating from information provider communicating objects and having to be consulted from information display communicating objects, where in a prior step, a system of reference is defined specifically for referencing in a unique manner a set of locations and providing, for each location of the set of locations, an identification. Information data are acquired and are stored, each information datum comprising an item of information to be disseminated provided by an information provider communicating object and a parameter indicating the identification of a location defined at the prior step and associated with the information. Stored information is accessed associated with the location by way of at least one information display communicating object situated at the location.

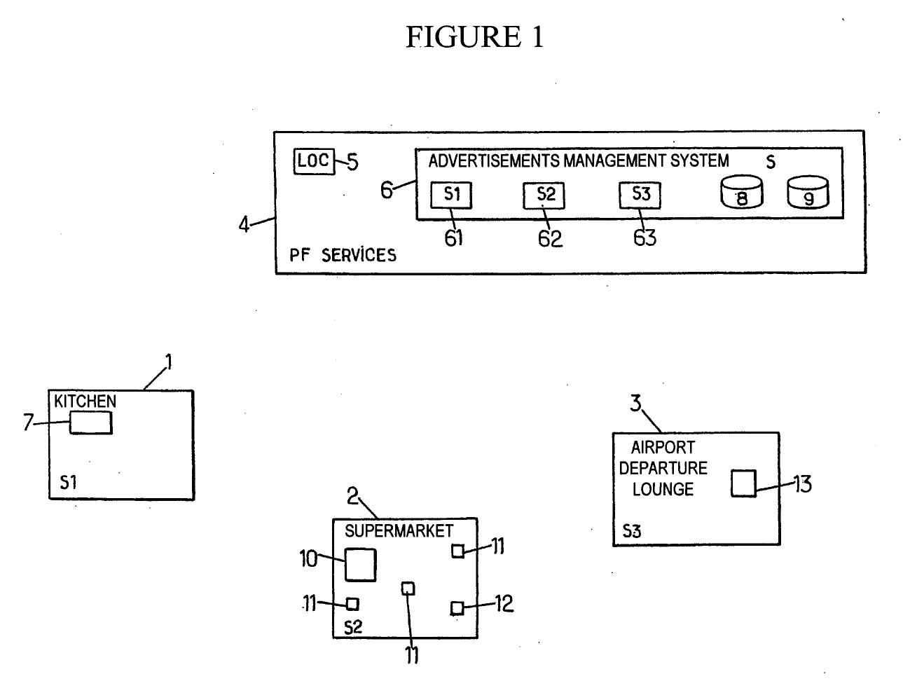

The present invention relates to the field of novel human interfaces through the intermediary of communicating objects. These communicating objects are objects having an inherent function and furnished with communication capabilities for sending and receiving information to or from in particular other communicating objects.

The communicating objects more particularly considered here are those making it possible to acquire or to deliver information originating from and destined for users of these objects, doing so by way of a considered location.

The communicating objects can be fixed or mobile. A communicating object can be dedicated to a single user, or conversely be multi-user.

Numerous locations are equipped with display panels intended to enable people passing regularly through these locations to communicate with one another. Some of these people compose messages on a piece of paper, then display them by fixing them, with the aid of glue or drawing pins, on the panel. This information is thereafter consulted, and possibly modified or removed by the people passing via these locations.

Such display panels are thus frequently used for example in company cafeterias. At home, the door of the refrigerator in the kitchen often serves as display panel for the shopping list, consulted, and completed as needed by the various members of the family, then finally recovered in order to go shopping.

Though these panels are very useful, they however comprise a certain number of limitations. Among the latter, may be cited for example that the information must be provided, respectively consulted only at the actual location of delivery.

An aim of the invention is to propose a method and a system for managing information making it possible to provide the same services as the display panels present at a location according to the prior art, or equivalent services calling upon senses other than sight, and adapting furthermore to the movements of the people desiring to use the service provided in association with a given location, even when they are not situated in the location in question.

Thus according to a first aspect, the invention proposes a method for managing information between communicating objects, said information originating from information provider communicating objects and having to be consulted from communicating objects delivering information, according to which:
in a prior step, a system of reference is defined specifically for referencing in a unique manner a set of locations and providing, for each of the locations of said set of locations, an identification;
data are acquired and are stored, each datum comprising an item of information to be disseminated provided by an information provider communicating object and a parameter indicating the identification of a location defined at the prior step and associated with said information;
stored information associated with said location by way of at least one information delivery communicating object situated at said location is accessed.

An information provider communicating object is an object having available means for allowing the entry by a user of an item of information that he desires to communicate.

A information delivery communicating object is an object having available means for allowing the delivery of information.

A communicating object can be at one and the same time a provider of information and also be an object able to deliver information.

A communicating object which is an information provider, respectively able to deliver information, acquires, respectively delivers, information in a manner dependent on the sensory interfaces with which it is furnished.

Thus, an information provider communicating object, according to the embodiments, is able to acquire information provided by a user from a keyboard, or from a touch screen, or else delivered vocally, etc.

In the same way, a communicating object intended to deliver information will be able to deliver the latter, according to the embodiments, by display on a screen, or in a vocal manner with the aid of a loudspeaker etc.

The acquisition of information tied to a defined location can be performed according to the embodiments, from the considered location or otherwise, with the aid of a communicating object allowing such entry.

The method according to the invention makes it possible to define information delivery devices at various locations.

The delivery of the information tied to a location is carried out from at least one communicating object furnished with delivering means and situated at the location considered. In embodiments, a communicating object may be situated in this location in a fixed manner. In other embodiments, delivering is performed on the screen of at least one communicating object carried by a mobile user, situated at the moment of delivering at the location considered. In certain cases, delivery will take place within the location considered at one and the same time by way of fixed objects and of mobile objects situated at the moment considered in the location.

Advantageously, the consultation of the information can furthermore be performed from an arbitrary locality by way of an information delivery communicating object, by providing the geographical identification of the location from which one desires to consult the information (this identification of the location can be carried out by the user, or preconfigured by the system).

According to a second aspect, the invention relates to a system for managing information between communicating objects implementing a method according to the first aspect of the invention.

According to a third aspect, the invention relates to an information management platform comprising at least two information management systems. The platform furthermore comprises means specifically for matching up the identification of locations in the system of reference of one of the two information management systems with the identification of said locations in the system of reference of the other of the two information management systems.

Other features and advantages of the present invention will appear in the description hereafter of exemplary nonlimiting embodiments with reference to the single FIGURE.

In the single FIGURE are represented three locations 1, 2 and 3.

A services platform 4 is arranged to propose and provide a set of services to users by way of communicating objects, doing so at a plurality of locations among which are included the locations 1, 2 and 3. Featuring among these services is a generic service S of information acquisition/delivery panel. This generic service takes the form in particular of services of advertisement panels S1, S2, S3 tied respectively to each of these three locations. Thus the information considered here is of the “advertisements” type.

The communicating objects considered hereafter are furnished with communication means, allowing the transmission of information in particular between communicating objects, and between them and the services platform 4.

The platform 4 has available a locating system 5 suitable for locating communicating objects, or even users. This locating can be initiated by the communicating object itself which is manifested in an active manner at the platform 4, or by the platform 4 itself.

Locating means according to varied technologies can be used. These locating means can be for example multi-sensor systems for complete positioning (GPS or triangulation by stations IEEE 802.11), or else isolated sensors relayed by a software infrastructure combining raw information arising from the sensors, or else positioning information written lastingly during the installation of fixed or rarely moved objects. Thus the locating information delivered by the locating means 5 can be of very diverse nature.

In the embodiment considered, the system 5 of the platform 4 is furthermore suitable for performing the identification, and if appropriate the authentication, of users.

To render the advertisement panel services, the platform 4 has available a management system for the advertisements 6. This system is composed of subsystems dedicated to each location having available an advertisement panel service. Represented in the single FIGURE are the information management subsystems 61, 62 and 63, respectively dedicated to the locations 1, 2 and 3.

Here, the platform 4 is centralized. In other embodiments, a system according to the invention will be able to comprise at least one platform comprising an advertisements management system, the platform being specifically for a given location, and situated in said location.

The advertisements management system 6 comprises a system of reference 8 in which each location 1, 2, 3 to which an advertisements management subsystem 61, 62, 63 refers is previously identified.

The advertisements management system 6 furthermore comprises a database 9.

The location 1 is, in the embodiment considered, the kitchen of the family of a user X. In this kitchen is disposed a fixed communicating object 7 comprising a touch screen. The communicating object 7 is for example arranged on the door of the refrigerator.

The advertisements management subsystem 61 is designed to acquire and store as a database 9 any new advertisement composed with the aid of a stylus from the touch screen. A new advertisement stored from the touch screen of the communicating object 7 is automatically associated by the advertisements management subsystem 61, and stored in the base 9 in association with the identification of the location 1 such as defined in the system of reference 8.

The subsystem 61 is furthermore suitable for displaying on the screen of the communicating object 7 the set of advertisements present in the base 9 associated with the location 1.

In the embodiment considered, each advertisement corresponds to an item of a list of shopping to be done by the user X.

Anyone from the family of this user can thus complete the shopping list displayed on the screen of the refrigerator 7 as needed.

They can also select a displayed advertisement and modify it or remove it, for example when they have purchased one of the items featuring on the list. The advertisements management subsystem 61 then records the advertisement in its modified form or removes the advertisement and updates the shopping list displayed on the screen.

According to the embodiments, the shopping list is displayed permanently, or conversely in a temporary manner. In the latter case, it can for example be accessible by selection of a user from a menu exhibited on the screen of the refrigerator 7. Advantageously, it can be displayed whilst detecting the presence of a user in the room.

In other embodiments, it will be possible when a user has been located in a location, to afford him access automatically from an advertisement provider communicating object situated in proximity to the user, to the acquisition of advertisements to be recorded in association with said location.

In the same way, in embodiments, it will be possible, when a user has been located in a location, to retrieve for him stored advertisements associated with said location from a communicating object able to deliver advertisements and situated in proximity to the user.

In an embodiment, the management system 6 according to the invention serves furthermore to exchange messages of diverse type between the members of the family, for example relating to family life (sharing of household tasks, scheduled meals out for each of the members of the family etc).

The location 2 is for example a supermarket. It is equipped with a communicating object 10 comprising a large screen, for example at the entrance to the store. It comprises a plurality of communicating objects 11 distributed in the supermarket 2.

The communicating objects 11 are stations equipped with a keyboard and a screen. Each station is intended for the entry of information composed with the aid of its keyboard by customers of the store and displayed on the screen of the station by the composer customer in the course of the composing. Once the customer has entered his advertisement on the station 11 and has validated this entry, the advertisements management subsystem 62 records the advertisement in the base 9, associating it with the identification of the supermarket 2 such as defined in the reference tag 8.

The subsystem 62 is suitable for enabling display of the whole set of advertisements recorded in the base 9 and associated with the supermarket 2 on the large screen of the communicating object 10.

Each customer in the supermarket can thus consult on this large screen the advertisements left by the other customers. They can also in their turn post an advertisement from a station 11.

Additional parameters can be taken into account in the management of an advertisement within the framework of the provision of the service S2, relating to the advertisements recorded in association with the location 2.

In an embodiment, any advertisement posted is recorded in the base 9 in association with an identification, and an authentication if appropriate, of the composer (a code, a fingerprint, etc.).

It can be defined that an advertisement previously posted by a customer may not be modified or removed from a station 11 other than by this same customer. Any modification or removal will therefore be effective and displayed on the large screen of the communicating object 10 only after a step of verification of its identification parameters.

In the embodiment considered, the user X has available a communicating object 12 of Wireless Personal Communicator type. The communicating object 12 is thus for example a communicating PDA (“Personal Digital Assistant”), a PC tablet, a mobile telephone, a Smart Phone, etc. It is subsequently named in a generic manner a Personal Communicator. The personal communicator 12 has available data entry and display means.

Advantageously when the user X is detected inside the supermarket 2, he is afforded access from his personal communicator 12 with the same functionalities for composing advertisements as those offered by the stations 11. As he is located inside the location 2, an advertisement that he enters will be by default associated with the location 2, in the embodiment considered. He can furthermore have access from his personal communicator 12 for example to the same functionality for consulting advertisements as that offered by the large screen of the communicating object 10.

In an embodiment, the user X, when he is situated in the supermarket 2, can have access by way of his personal communicator 12, to the service S1 relating to the display panel relating to the location 1 of his kitchen.

Thus, by way of a software application managed by the services platform 4 and with which he exchanges from his personal communicator 12, the user X communicates to the advertisements management system 6 the identification of the reference location of the display panel service which he desires to access. In the case considered, the user X thus provides the identification of the kitchen 1 such as defined in the reference tag 8. Advantageously, the identifications that the user employs commonly are prerecorded in a directory of his personal communicator 12.

The advertisements management subsystem 61 tied to the location 1 communicates thereafter with the user X by way of the personal communicator 12, after possibly a step of identification, or even of authentication, so as to offer him the functionalities of consultation, of addition, of modification or of removal of the advertisements associated with the kitchen 1 and similar to those he had within his kitchen. It will be noted that when the user X is in his kitchen 1, he can have access via his personal communicator 12 and via the communicating object 7 to the display panel service S1.

The location 3 is a departure lounge in an airport. The advertisements management subsystem 63 allows a set of people benefiting from a service S3, the provision of the advertisements management service S3 tied to this location. The service S3 now described requires that each beneficiary has available a personal communicator 13. The latter may or may not be dedicated to the service S3. It is furnished with consultation and entry means. Three types of facilities can be chosen: the first facility makes it possible to consult, at any location managed by the platform 4, advertisements stored in the base 9 in association with the location 3. The second facility allows, at any location managed by the platform 4, consultation, composition, removal and modification of these advertisements. The third facility allows, consultation at any location managed by the platform 4, and composition, removal and modification of these advertisements within the location 3.

A beneficiary Y has available a personal communicator 13. When the beneficiary Y is detected, identified, and if appropriate authenticated, at a location 1,2,3 of the platform 4, the advertisements management system 6 causes on his personal communicator 13 the delivery of the advertisements associated with the location 3 and stored in the base 9, and affords him access to the functionalities of consultation of advertisements, or even of composition, removal and modification of these advertisements to which he has access as a function of the facility picked (that can be regained following the step of identification).

Optionally, a topic parameter could be assigned to each of these advertisements and stored in association with the advertisement in the base 9. The topics are for example finance, travel etc. Options relating to the facilities can furthermore afford the beneficiary access to selectively a single or several of these topics, by consultation and/or by entry. Thus as a function of the step of identification, and if appropriate of authentication, the beneficiary may consult only the advertisements of the topic or topics covered by the facility which has been picked. According to the embodiments, when entering an advertisement, the topic will be able to be assigned, according to the embodiments, by the beneficiary or automatically by the advertisements management subsystem 63 as a function of the facility picked.

At any location of the platform 4, a beneficiary Y having chosen a facility allowing him to compose an advertisement will be able, from his personal communicator, to enter an advertisement which, after validation of the entry by the user Y, will be stored automatically in the base 9 in association with the location 3.

Thus a method and a system for managing information according to the invention allows the consultation and the composition of information with reference to a location. Consultation is performed at the actual location. Moreover, consultation can furthermore take place remotely.

According to the embodiments, consultation and entry of information are performed by way of delivery and/or entry devices which can be fixed or mobile, dedicated or otherwise.

The invention makes it possible to take account readily of one or more parameters for consultating or composing the information, so as to render a selective service as a function of these parameters. These parameters may relate to the locating of the user, to this locating with respect to the reference location of the information acquisition/delivery service which he desires to access. These parameters may be dependent on his identity and make it possible to take into account preferences that he has given, facilities chosen etc. It will thus be possible, for example, if so desired, to monitor and limit the people authorized to post and/or consult the information, and likewise the remote access.

In embodiments, it will be possible however to afford a user access to the functions of consultation and/or of entry of information tied to a location on the simple determination of the presence of the user in the location considered.

The invention allows a user access to the information on presentation of the identification of the location of interest. According to the embodiments, the identification will be able to be provided in an active manner by the user via the communicating object used, prerecorded in the communicating object (by default and possibly modifiable) or associated by the management system with the information, as a function for example of the location in which the communicating object used by the user is situated. The identification of the location is thus used as a means for addressing the information.

Any type of location can be identified and form the subject of a system for managing information according to the invention.

Various models for identifying locations may possibly respectively be used according to the reference tags: the GPS coordinates of the barycenter of the location, a postal address, a point on a map (see also the models proposed in point 3 of the document “An infrastructure template for scalable location-based services” by Thibaud Flury and Gilles Privat).

The most suitable system of reference for the locations considered for each embodiment will be chosen. Specifically, according to the embodiments, a system will be able to identify several rooms of one and the same property, or else locations distributed across various countries, etc.

Such a generic service S can form part of a directory of services such as described in patent application FR 03 06497. It can be offered spontaneously to a user when his entry into a location is detected, to have access to the information acquisition/delivery service tied to this location, as a function possibly of his identification, or even of his authentication.

Moreover, it is possible to make systems according to the invention cooperate using distinct systems of reference, thereby making it possible to harness various information sources. To do this it suffices for the platform considered and comprising the various information management systems, to have available means making it possible to effect the link between the respective identifications of a determined location.

1. A method for managing information between communicating objects, said information originating from information provider communicating objects and considered by communicating objects able to deliver information, said method comprising the steps:
acquiring and storing data comprising an item of information to be disseminated by an information provider communicating object and comprising a parameter identifying a location associated with said item of information, the location belonging to a set of locations identified in a unique manner in a system of reference; and
delivering at least one stored item of information associated with said location by way of at least one communicating object able to deliver information and situated at said location.

2. The method as claimed in claim 1, wherein said communicating object able to deliver information comprises an information delivery device fixed at a location, said information delivery device affording access to stored information associated with said location.

3. The method as claimed in claim 1, wherein a stored item of information associated with a location is delivered by way of a communicating object able to deliver information and providing the parameter indicating the identification of said location.

4. The method as claimed in claim 1, comprising the steps of:
determining a location in which a communicating object able to deliver information is situated, and
delivering stored information associated with said location by way of said communicating object.

5. The method as claimed in claim 1, comprising the steps of:
determining a location in which an object providing information is situated, and
acquiring and storing at least one datum comprising an item of information provided by way of said object providing information and a parameter indicating the identification of said location.

6. The method as claimed in claim 1, comprising the steps of:
carrying out a step of identification of a user of a communicating object able to deliver information, and
affording access of the user to stored information associated with a location by way of said communicating object as a function of at least the results of this step of identification.

7. The method as claimed in claim 6, wherein furthermore a step of authentication of the user is carried out, and access to associated stored information is a function of at least the results of this step of authentication.

8. The method as claimed in claim 1, wherein said information provider communicating object associated with a location comprises an information acquisition device fixed to said location.

9. The method as claimed in claim 1, comprising the step of:
carrying out at least one step of identification of a user of an information provider communicating object, and
acquiring and storing at least one datum comprising an item of information provided by the user by way of said object as a function of at least the results of this step of identification.

10. The method as claimed in claim 9, wherein furthermore a step of authentication of the user is carried out, and the acquisition and the storage of the datum is a function of at least the results of this step of authentication.

11. The method as claimed in claim 1, comprising the step of triggering, when a communicating object is located for the first time in a location, an operation destined for said communicating object, prompting it to provide an item of information when the communicating object is an information provider, and to have access to stored information associated with said location when the communicating object is able to deliver information.

12. A system for managing information between communicating objects by way of a location, said information originating from information provider communicating objects and considered by communicating objects able to deliver information, said system comprising:
means for acquiring and storing data comprising an item of information to be disseminated provided by an information provider communicating object and comprising a parameter identifying a location associated with said item of information, the location belonging to a set of locations identified in a unique manner in a system of reference; and
means for delivering at least one stored item of information associated with said location by way of at least one communicating object able to deliver information and situated at said location.

13. A platform for managing information comprising at least two information management systems, each information management system comprising:
means for acquiring and storing data comprising an item of information to be disseminated provided by an information provider communicating object and comprising a parameter indicating an identification of a location associated with said item of information, the location belonging to a set of locations identified in a unique manner in a system of reference;
means for delivering at least one stored item of information associated with said location by way of at least one communicating object able to deliver information and situated at said location the platform comprising means specifically for matching up the location identification in the system of reference of one of the two information management systems with the location identification in the system of reference of the other of the two information management systems.
